(19) United States
(12) Patent Application Publication
(10) Pub. No.: US 2008/0126247 A1
(43) Pub. Date: May 29, 2008

(54) Method to entice individuals to obtain auto insurance

(76) Inventor: Iverson Traylor, Westchester, CA (US)

Correspondence Address: JAMES RAY & ASSOCIATES, 2640 PITCAIRN ROAD, MONROEVILLE, PA, 15146, US

(21) Appl. No.: 11/818,779

(22) Filed: Jun. 15, 2007

Related U.S. Application Data
(60) Provisional application No. 60/813,865, filed on Jun. 15, 2006.

(51) Int. Cl. G06Q 40/00

(52) U.S. Cl. 705/39

(57) ABSTRACT

A method of enticing an individual to obtain and maintain automobile insurance. The method includes the steps of offering a potential policy holder an accruing cash value according to a predetermined schedule and establishing a separate account for receiving deposits for the policy holder. Depositing a predetermined portion of policy holder's policy premiums into the account set which accrue tax deferred to the policy holder until used and finally periodically allowing the policy holder to use their accrued cash value to at least one of offset their policy premium, pay part of their deductible in an event in which they are involved in an accident, pay damages for person or property that the policy holder may become liable and a return of their accrued cash value upon termination of their policy after a predetermined time period.

### CROSS REFERENCE TO RELATED APPLICATION

This patent application is related to and claims priority from U.S. Provisional Patent Application Ser. No. 60/813,865 filed Jun. 15, 2006.

### FIELD OF THE INVENTION

The present invention relates, in general, to insurance and, more particularly, this invention relates to automobile insurance policies wherein a percentage of the premium paid to the insurance carrier will accumulate into a cash value that will become available to the insured individual later in the life of the policy that can be used for premiums, deductibles or to pay damage to a personal vehicle.

### BACKGROUND OF THE INVENTION

Prior to the conception and development of the present invention, as is generally well known in the prior art, life insurance policies exist wherein a percentage of the premium paid to the insurance carrier will accumulate into a cash value that will become available to the insured individual later in the life of the policy. However, there are no automobile insurance policies that provide a similar benefit to the insured. Therefore, many motorists choose to remain uninsured and have little or no interest in obtaining automobile insurance. As a result, when uninsured motorists are involved in accidents, they create situations wherein increased claims are made to insurance companies.

### SUMMARY OF THE INVENTION

The present invention provides a method of enticing an individual to obtain and maintain automobile insurance. The method includes offering a potential policy holder a cash value which will accrue and establishing a separate account for receiving deposits for the policy holder. The method includes depositing a predetermined portion of policy holder's policy premiums into the account that will accrue tax deferred until used and periodically allowing the policy holder to use the accrued cash value to at least one of offset their policy premium, pay part of their insurance claim deductible in event they are involved in an accident, pay damages for property or person for which they may be liable and receive a return of their accrued cash value upon termination of their policy after a predetermined time period.

### OBJECTS OF THE INVENTION

It is, therefore, one of the primary objects of the present invention to provide a method of enticing an individual to obtain and maintain automobile insurance.

Another object of the present invention is to provide a method of enticing an individual to obtain and maintain automobile insurance which will offer a potential policy holder an accruing cash value.

Still another object of the present invention is to provide a method of enticing an individual to obtain and maintain automobile insurance in which the cash value will be tax deferred to the policy holder until used.

Yet another object of the present invention is to provide a method of enticing an individual to obtain and maintain automobile insurance which will allow the policy holder to use accrued cash value to at least one of offset their policy premium, pay part of their insurance claim deductible in event they are involved in an accident, pay damages for property or person for which they may become liable and a return of their accrued cash value upon termination of their policy after a predetermined time period.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the appended claims.

### BRIEF DESCRIPTION OF A PRESENTLY PREFERRED AND VARIOUS ALTERNATIVE EMBODIMENTS OF THE INVENTION

According to the present invention there is provided a method of enticing an individual to obtain and maintain automobile insurance. The method includes the steps of offering a potential policy holder an accruing cash value according to a predetermined schedule and establishing a separate account for receiving deposits for each new policy holder. When the premium is received a predetermined portion is deposited into the policy holder's account. Preferably, the predetermined portion of the premium deposited into the account will be between 2.0 to about 5.0 percent of the premium. However, this amount may be greater under market conditions. The deposits will accrue tax deferred to the policy holder until used. Finally, the method includes periodically allowing the policy holder to use their accrued cash value to at least one of offset their policy premium, pay part of their deductible in event they are involved in an accident, pay damages for property or person for which they become liable and a return of their accrued cash value upon termination of their policy after a predetermined time period, preferably five years. In the insurance industry the predetermine period is commonly known as a surrender period. In the preferred embodiment the predetermined period is five years.

In a presently preferred embodiment, the method includes an additional step of accruing an additional amount to the amounts deposited into the policy holder's separate account at a fixed rate or floating rate. In the preferred embodiment the rate is between about 1.0 percent and about 2.0 percent. However, this may vary according to market conditions.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A method of enticing an individual to obtain and maintain automobile insurance, said method including the steps of:
(a) offering a potential policy holder a cash value which will accrue according to a predetermined schedule;
(b) establishing a separate account for receiving deposits for said policy holder;
(c) depositing a predetermined portion of policy holder's policy premiums into said account set up in step (b) that will accrue tax deferred to said policy holder until used; and
(d) periodically allowing said policy holder to use their accrued cash value to at least one of offset their policy premium, pay part of their deductible in event they are involved in an accident, pay damages for person or property that the policy holder may become liable and a return of their accrued cash value upon termination of their policy after a predetermined time period.

2. A method, according to claim 1, wherein said method includes an additional step of paying an additional amount at a predetermined rate on monies deposited in step (c) into said policy holder's account set up in step (b).

3. A method, according to claim 2, wherein said predetermined rate paid is between about 1.0 percent and about 2.0 percent.

4. A method, according to claim 3, wherein said predetermined time period is five years.

5. A method, according to claim 1, wherein said predetermined portion of said policy holder's policy premiums deposited into said account is between about 2.0 percent to about 4.0 percent.
